(19) United States
(12) Patent Application Publication
(10) Pub. No.: US 2014/0287197 A1
(43) Pub. Date: Sep. 25, 2014

(54) WIND DIRECTION-CONTROLLING PLATE AND MANUFACTURING METHOD FOR WIND DIRECTION-CONTROLLING PLATE

(71) Applicant: Win Tech Polymer Ltd., Tokyo (JP)

(72) Inventors: Kosuke Maruyama, Fuji-shi (JP); Kazuya Goshima, Fuji-shi (JP)

(73) Assignee: Win Tech Polymer Ltd., Tokyo (JP)

(21) Appl. No.: 14/356,365

(22) PCT Filed: Oct. 31, 2012
(86) PCT No.: PCT/JP2012/078203

§ 371 Date: May 5, 2014

(30) Foreign Application Priority Data
Nov. 8, 2011 (JP) 2011-244496

(51) Int. Cl. B29C 45/00

(52) U.S. Cl. CPC B29C 45/0005
USPC 428/192; 264/328.1; 428/220

(57) ABSTRACT

Provided is a wind direction-controlling plate, which is obtained by molding a polybutylene terephthalate resin composition that has high fluidity when melted and which has excellent external appearance and mechanical properties. A wind direction-controlling plate is manufactured using a polybutylene terephthalate resin composition comprising polybutylene terephthalate resin, polyethylene terephthalate resin and glass fibers as starting material. The plate has a board shape in which the length in the long direction is two or more times the length in the short direction, has a thickness of 0.7 mm to 4 mm, and is obtained by injection molding the polybutylene terephthalate resin composition from an end in the long direction or a gate near same.

### TECHNICAL FIELD

The present invention relates to a wind direction-controlling plate made of a polybutylene terephthalate resin composition, and a method of producing the wind direction-controlling plate.

### BACKGROUND ART

The polybutylene terephthalate resin is excellent in, for example, mechanical characteristics, electrical characteristics, heat resistance, chemical resistance, and solvent resistance and is therefore widely used as engineering plastic in various applications such as automobile parts and electrical and electronic parts.

In recent years, a reduction in size and weight of industrial molded articles has been increasingly demanded. Against such a demand, for example, a polybutylene terephthalate resin that is used in applications to automobiles or electrical and electronic equipment is desired to be improved in the fluidity when melted, without reducing the mechanical characteristics.

Patent Document 1 describes a method of improving fluidity by melt blending a combination of a specific thermoplastic resin and a compound having at least three specific functional groups. However, the fluidity-improving effect described in Patent Document 1 is insufficient, and also the mechanical properties show a tendency of decrease.

Patent Document 2 reports on a method of providing a molded article having excellent impact resistance and chemical resistance, being glossy, and having good surface appearance by using a polybutylene terephthalate resin and a polyester resin having a crystallization speed slower than that of the polybutylene terephthalate resin or an amorphous resin. However, the material described in Patent Document 2 has low mechanical characteristics. In addition, in order to obtain good appearance, molding at a high mold temperature is required.

Furthermore, Patent Document 3 proposes a method of improving fluidity by blending a specific olefin-based copolymer with a polybutylene terephthalate resin. However, this method has a problem that the rigidity and strength of the resin molded article are low.

Thus, it is difficult to develop a polybutylene terephthalate resin composition satisfying both high mechanical properties and fluidity when melted.
[Patent Document 1] Japanese Unexamined Patent Application, Publication No. H07-304970
[Patent Document 2] Japanese Unexamined Patent Application, Publication No. 2003-26908
[Patent Document 3] Japanese Unexamined Patent Application (Translation of PCT Application), Publication No. 2008-501835

### DISCLOSURE OF THE INVENTION

### Problems to be Solved by the Invention

Meanwhile, the wind direction-controlling plate of, for example, an air-conditioner is a part that is visible from the outside and is therefore required to have excellent appearance. In addition, the position of the gate when the plate is produced by injection molding is limited to an end of the wind direction-controlling plate from the viewpoint of design. Furthermore, in order to avoid a weld from occurring at the design portion, molding with a single gate, without providing a plurality of gates, is required. Accordingly, the resin composition as a raw material is required to have high fluidity. In addition, since the wind direction-controlling plate is a thin and long component, the resin composition as a raw material is required to have high flexural modulus, flexural strength, and Charpy impact value.

However, as described above, since the situation is hard enough to develop a polybutylene terephthalate resin composition having excellent mechanical properties and high fluidity when melted, a polybutylene terephthalate resin composition that is suitable as a raw material of a wind direction-controlling plate has not been developed yet.

The present invention was made for solving the above-described problems, and it is an object of the invention to provide a wind direction-controlling plate made by molding a polybutylene terephthalate resin composition having high fluidity when melted and having excellent appearance and mechanical properties.

### Means for Solving the Problems

The present inventors have diligently studied to solve the above-described problems. As a result, the inventors have found that a wind direction-controlling plate made of a polybutylene terephthalate resin composition containing a polybutylene terephthalate resin, a polyethylene terephthalate resin, and glass fiber and having a melt viscosity of 0.10 kPa·s or more and 0.30 kPa·s or less at a temperature of 260° C. and a shear rate of 1000 sec⁻¹ can have excellent appearance and excellent mechanical properties such as flexural properties, even if the wind direction-controlling plate is in a plate shape in which the length in the longitudinal direction is twice or more that in the short-length direction, has a thickness of 0.7 mm or more and 4 mm or less, and has a gate portion at an end in the longitudinal direction of the plate or near the end, and have accomplished the present invention. More specifically, the present invention provides the following aspects.

(1) A wind direction-controlling plate being in a plate shape in which the length in the longitudinal direction is twice or more that in the short-length direction and having a thickness of 0.7 mm or more and 4 mm or less, wherein the wind direction-controlling plate is formed by injection molding of a polybutylene terephthalate resin composition containing a polybutylene terephthalate resin, a polyethylene terephthalate resin, and glass fiber and having a melt viscosity of 0.10 kPa·s or more and 0.30 kPa·s or less at a temperature of 260° C. and a shear rate of 1000 sec⁻¹ from a gate at an end in the longitudinal direction of the plate or near the end.

(2) The wind direction-controlling plate according to aspect (1), wherein the polybutylene terephthalate resin composition has a flexural modulus of 15000 MPa or more and a flexural strength of 170 MPa or more measured in accordance with ISO 178 and a Charpy impact value of 7 kJ/m² or more measured in accordance with ISO 179/1 eA.

(3) The wind direction-controlling plate according to aspect (1) or (2), wherein the polybutylene terephthalate resin composition has a mass ratio of the polybutylene terephthalate resin to the polyethylene terephthalate resin (content of polybutylene terephthalate resin/content of polyethylene terephthalate resin) of 4/6 or more and 7/3 or less; contains the glass fiber in a content of 80 parts by mass or more and 140 parts by mass or less based on 100 parts by mass of the sum of the content of the polybutylene terephthalate resin and the content of the polyethylene terephthalate resin; further contains an inorganic filler other than the glass fiber in a content of 40 parts by mass or less; and further contains a glycerol fatty acid partial ester in a content of 3 parts by mass or less.

(4) The wind direction-controlling plate according to aspect (3), wherein the inorganic filler is talc having a particle diameter of 10 μm or more and 30 μm or less.

(5) The wind direction-controlling plate according to any one of aspects (1) to (4), wherein the plate includes rotary shaft portions extending from both ends of the wind direction-controlling plate in the longitudinal direction and transmitting a driving force to the plate; and the gate is disposed on one of the rotary shaft portions or at the end of one of the rotary shaft portions in the axial direction.

(6) A method of producing the wind direction-controlling plate according to aspect (5) by injection molding, wherein the injection molding is performed controlling the polybutylene terephthalate resin composition in a molten state, passing through the rotary shaft portions, in a cavity so as to have a shear rate of 1×10³/sec or more and 1×10⁶/sec or less, at a holding pressure of 30 MPa or more and 100 MPa or less and a mold temperature of 100° C. or less.

### Effects of the Invention

According to the present invention, the wind direction-controlling plate can have excellent appearance and mechanical properties in spite of the molding of a polybutylene terephthalate resin composition having high fluidity when melted.

### BRIEF DESCRIPTION OF THE DRAWINGS

FIG. 1 is a schematic view of an example of the wind direction-controlling plate.

### EXPLANATION OF REFERENCE NUMERALS

1: wind direction-controlling plate
10: wind direction-controlling portion
11: rotary shaft portion
12: gate portion

### PREFERRED MODE FOR CARRYING OUT THE INVENTION

Embodiments of the present invention will now be described. Note that the present invention is not limited to the following embodiments.

### Polybutylene Terephthalate Resin Composition

The wind direction-controlling plate of the present invention is made of a specific polybutylene terephthalate resin composition. The specific polybutylene terephthalate resin composition contains a polybutylene terephthalate resin, a polyethylene terephthalate resin, and glass fiber.

### [Polybutylene Terephthalate Resin]

The polybutylene terephthalate resin is prepared by polycondensation of a dicarboxylic acid component containing at least terephthalic acid or its ester-forming derivative (e.g., a C₁₋₆ alkyl ester or acid halide) and a glycol component containing at least alkylene glycol having four carbon atoms (1,4-butanediol) or its ester-forming derivative (e.g., an acetylated derivative). The polybutylene terephthalate resin is not limited to a homo-polybutylene terephthalate resin and may be a copolymer containing 60 mol % or more (in particular, 75 mol % or more and 95 mol % or less) of a butylene terephthalate unit.

The amount of the end carboxyl groups of the polybutylene terephthalate resin is not particularly limited as long as it does not impair the purpose of the present invention. The amount of the end carboxyl groups of the polybutylene terephthalate resin is preferably 30 meq/kg or less and more preferably 25 meq/kg or less.

The polybutylene terephthalate resin may have any intrinsic viscosity within a range that does not impair the purpose of the present invention. The polybutylene terephthalate resin preferably has an intrinsic viscosity (IV) of 0.60 dL/g or more and 1.2 dL/g or less, more preferably 0.65 dL/g or more and 0.9 dL/g or less. The polybutylene terephthalate resin composition containing a polybutylene terephthalate resin having an intrinsic viscosity within such a range has particularly excellent moldability. The intrinsic viscosity can also be adjusted by blending polybutylene terephthalate resins having different intrinsic viscosities. For example, a polybutylene terephthalate resin having an intrinsic viscosity of 0.9 dL/g can be prepared by blending a polybutylene terephthalate resin having an intrinsic viscosity of 1.0 dL/g and a polybutylene terephthalate resin having an intrinsic viscosity of 0.7 dL/g. The intrinsic viscosity (IV) of a polybutylene terephthalate resin can be measured, for example, in o-chlorophenol at 35° C.

In the preparation of the polybutylene terephthalate resin, examples of the dicarboxylic acid component (comonomer component) other than terephthalic acid and its ester-forming derivatives include C₈₋₁₄ aromatic dicarboxylic acids such as isophthalic acid, phthalic acid, 2,6-naphthalenedicarboxylic acid, and 4,4′-dicarboxy diphenyl ether; C₄₋₁₆ alkanedicarboxylic acids such as succinic acid, adipic acid, azelaic acid, and sebacic acid; C₅₋₁₀ cycloalkanedicarboxylic acids such as cyclohexanedicarboxylic acid; and ester-forming derivatives of these dicarboxylic acid components (e.g., C₁₋₆ alkyl ester derivatives and acid halides). These dicarboxylic acid components may be used alone or in combination of two or more thereof.

Among these dicarboxylic acid components, more preferred are C₈₋₁₂ aromatic dicarboxylic acids such as isophthalic acid; and C₆₋₁₂ alkanedicarboxylic acids such as adipic acid, azelaic acid, and sebacic acid.

In the preparation of the polybutylene terephthalate resin, examples of the glycol component (comonomer component) other than 1,4-butanediol include C₂₋₁₀ alkylene glycols such as ethylene glycol, propylene glycol, trimethylene glycol, 1,3-butylene glycol, hexamethylene glycol, neopentyl glycol, and 1,3-octanediol; polyoxyalkylene glycols such as diethylene glycol, triethylene glycol, and dipropylene glycol; alicyclic diols such as cyclohexanedimethanol and hydrogenated bisphenol A; aromatic diols such as bisphenol A and 4,4′-dihydroxybiphenyl; C₂₋₄ alkylene oxide adducts of bisphenol A such as ethylene oxide 2-mole adduct of bisphenol A and propylene oxide 3-mole adduct of bisphenol A; and ester-forming derivatives of these glycols (such as acetylated derivatives). These glycol components can be used alone or in combination of two or more thereof.

Among these glycol components, more preferred are C₂₋₆ alkylene glycols such as ethylene glycol and trimethylene glycol; polyoxyalkylene glycols such as diethylene glycol; and alicyclic diols such as cyclohexanedimethanol.

Usable examples of the comonomer components other than the dicarboxylic acid component and the glycol component include aromatic hydroxycarboxylic acids such as 4-hydroxybenzoic acid, 3-hydroxybenzoic acid, 6-hydroxy-2-naphthoic acid, and 4-carboxy-4′-hydroxybiphenyl; aliphatic hydroxycarboxylic acids such as glycolic acid and hydroxycaproic acid; C₂₋₁₂ lactones such as propiolactone, butyrolactone, valerolactone, and caprolactone (e.g., ε-caprolactone); and ester-forming derivatives of these comonomer components (e.g., C₁₋₆ alkyl ester derivatives, acid halides, and acetylated derivatives).

### [Polyethylene Terephthalate Resin]

The polyethylene terephthalate resin is a polyester resin that is prepared by polycondensation of a terephthalic acid or its ester-forming derivative (e.g., a C₁₋₆ alkyl ester or acid halide) and an ethylene glycol or its ester-forming derivative (e.g., an acetylated derivative) in accordance with a known method.

The polyethylene terephthalate resin may be modified by copolymerization with a small amount of a modification component that gives a repeating unit other than the terephthaloyl unit and the ethylene dioxy unit within a range that does not impair the purpose of the present invention. The amount of the repeating unit other than the terephthaloyl unit and the ethylene dioxy unit contained in the polyethylene terephthalate resin is preferably less than 4 mol %, more preferably 3 mol % or less, and most preferably 2 mol % or less based on the total amount of the repeating units of the polyethylene terephthalate resin.

In the present invention, the mass ratio of the polybutylene terephthalate resin to the polyethylene terephthalate resin (content of polybutylene terephthalate resin/content of polyethylene terephthalate resin) is preferably 4/6 or more and 7/3 or less. A mass ratio of 4/6 or more provides satisfactory surface appearance and is therefore preferred, and a mass ratio of 7/3 or less provides an excellent molding cycle and is therefore preferred. The range of the mass ratio is more preferably 5/5 or more and 6.5/3.5 or less.

### [Glass Fiber]

As the glass fiber, any known glass fiber can be preferably used. There are no limitation in the diameter and the shape, such as a cylindrical shape, cocoon shaped cross-section, or oblong cross-section, of the glass fiber and the length and the method of cutting glass in production of chopped strands or roving. In the present invention, the type of glass is also not limited, and E-glass and corrosion resistant glass containing zirconium element in the composition are preferred because of their qualities.

As described above, the length and the diameter of the glass fiber may be within common ranges. For example, glass fiber having a fiber length of 2.0 mm or more and 6.0 mm or less and a fiber diameter of 9.0 μm or more and 14.0 μm or less can be used.

In order to improve the interfacial properties between the glass fiber and a resin matrix, glass fiber surface treated with an organic treating agent such as an amino silane compound or an epoxy compound is particularly preferably used. In particular, glass fiber treated with 1% by mass or more, shown as the loss on heating, of the organic treating agent is preferably used. As the amino silane compound or the epoxy compound used for such glass fiber, any known amino silane compound or epoxy compound can be preferably used.

The content of the glass fiber in the resin composition is not particularly limited and is preferably controlled to 80 parts by mass or more and 140 parts by mass or less based on 100 parts by mass of the sum of the content of the polybutylene terephthalate resin and the content of the polyethylene terephthalate resin. A content of the glass fiber of 80 parts by mass or more provides high rigidity and is therefore preferred, and a content of 140 parts by mass or less provides satisfactory fluidity in molding and is therefore preferred. The content of the glass fiber is more preferably 90 parts by mass or more and 130 parts by mass or less.

### [Other Components]

The polybutylene terephthalate resin composition preferably contains a polyhydric alcohol fatty acid partial ester as a fluidity improving agent and an inorganic filler other than the glass fiber, in addition to the above-mentioned essential components.

The polyhydric alcohol fatty acid partial ester is preferably a partial ester of a polyhydric alcohol, such as ethylene glycol, propylene glycol, glycerol, polyglycerol, or pentaerythritol, and a saturated fatty acid of which alkyl group usually having 7 to 21 carbon atoms, such as caprylic acid, capric acid, lauric acid, myristic acid, palmitic acid, stearic acid, 12-hydroxystearic acid, arachidic acid, or behenic acid, or an unsaturated fatty, such as decenoic acid, undecenoic acid, dodecenoic acid, tetradecenoic acid, oleic acid, erucic acid, linoleic acid, or ricinoleic acid. In the present invention, in particular, a glycerol fatty acid partial ester is preferably used.

The use of a polyhydric alcohol fatty acid partial ester further enhances the fluidity of the polybutylene terephthalate resin composition when melted and is therefore preferred.

The polyhydric alcohol fatty acid partial ester used in the present invention preferably has a hydroxyl value of 200 or more and 1000 or less measured in accordance with an Oil Chemists' Society method: 2,4,9,2-71 hydroxyl value (pyridine-acetic anhydride method). A hydroxyl value of 200 or more provides a tendency of further enhancing the fluidity. However, a too high hydroxyl value causes excess reaction between the polyhydric alcohol fatty acid partial ester and the polybutylene terephthalate to reduce the molecular weight of the polybutylene terephthalate resin, which may deteriorate the excellent characteristics such as mechanical characteristics, heat resistance, and chemical resistance.

The content of the polyhydric alcohol fatty acid partial ester in the resin composition is not particularly limited and is preferably 3 parts by mass or less. A content of the polyhydric alcohol fatty acid partial ester of 3 parts by mass or less can achieve both high mechanical strength and high fluidity and is therefore preferred. The content is more preferably 0.1 parts by mass or more and 2.0 parts by mass or less.

Examples of the inorganic filler other than the glass fiber include fibrous fillers other than glass fiber, granular fillers, and tabular fillers.

Examples of the fibrous fillers other than glass fiber include asbestos fiber, silica fiber, silica/alumina fiber, alumina fiber, zirconia fiber, boron nitride fiber, silicon nitride fiber, boron fiber, potassium titanate fiber, and fibrous materials of metals such as stainless steel, aluminum, titanium, copper, and brass.

Examples of the granular fillers include granular silicates such as silica, quartz powders, glass beads, milled glass fiber, glass balloons, glass powders, calcium silicate, aluminum silicate, kaolin, talc, clay, diatom earth, and wollastonite; metal oxides such as iron oxide, titanium oxide, zinc oxide, antimony trioxide, and alumina; metal carbonates such as calcium carbonate and magnesium carbonate; metal sulfates such as calcium sulfate and barium sulfate; and ferrite, silicon carbide, silicon nitride, boron nitride, and various metal powders.

Examples of the tabular fillers include mica, glass flakes, and various metal foils.

In the present invention, as the inorganic filler other than the glass fiber, a granular filler or a tabular filler is preferably used. In particular, talc or mica is preferably used, and talc having a particle size of 10 μm or more and 30 μm or less is most preferably used for improving the appearance.

The content of the inorganic filler other than the glass fiber in the resin composition is not particularly limited and is preferably 40 parts by mass or less. A content of 40 parts by mass or less can achieve both good surface appearance and high mechanical strength and is therefore preferred. A content of 30 parts by mass or less is more preferred. In the present invention, the use of an inorganic filler other than the glass fiber together with stabilizes the strand in extrusion, compared to the case of using only the glass fiber, to allow easy pelletizing and is therefore preferred.

The polybutylene terephthalate resin composition may further contain a component other than the polyhydric alcohol fatty acid partial ester and the inorganic filler other than the glass fiber within a range that does not impair the effects of the present invention. For example, an additive, such as a nucleating agent, a pigment, an antioxidant, a plasticizer, a lubricant, a mold releasing agent, or a flame retardant, may be added to the polybutylene terephthalate resin composition for imparting a desired property.

In an alloy of a polyester-based resin, a phosphorus-based stabilizer is usually added as a transesterification inhibitor. However, the phosphorus-based stabilizer has a risk of inhibiting the reaction of a fluidity improving agent, and the addition in an excess amount may not sufficiently exhibit the effect of increasing the fluidity. Accordingly, in the polybutylene terephthalate resin composition of the present invention, the phosphorus-based stabilizer is preferably not contained, or even if contained, the amount should be very small.

### [Method of Producing Polybutylene Terephthalate Resin Composition]

The specific aspect of the method of preparing the polybutylene terephthalate resin composition is not particularly limited. The resin composition can be prepared by a known method and general equipment that are usually used in preparation of a resin composition and its molding. For example, the resin composition can be prepared as a pellet for molding by mixing necessary components and kneading the mixture with a single- or twin-screw extruder or another melt-kneading apparatus. A plurality of the extruders or the melt-kneading apparatuses may be used. All the components may be simultaneously fed from a hopper, or a part of the components may be fed from a side feed port.

### [Physical Properties of Polybutylene Terephthalate Resin Composition]

The polybutylene terephthalate resin composition used in the present invention has high fluidity when melted. The melt viscosity measured in accordance with ISO 11443 at a temperature of 260° C. and a shear rate of 1000 sec⁻¹ can be adjusted to 0.10 kPa·s or more and 0.30 kPa·s or less.

The polybutylene terephthalate resin composition used in the present invention has satisfactory flexural properties. The flexural modulus and the flexural strength measured in accordance with ISO 178 can be adjusted to 15000 MPa or more and 170 MPa or more, respectively.

The polybutylene terephthalate resin composition used in the present invention has a high Charpy impact value. The Charpy impact value measured in accordance with ISO 179/1 eA can be adjusted to 7 kJ/m² or more.

### Method of Producing Wind Direction-Controlling Plate

The wind direction-controlling plate can be produced from the polybutylene terephthalate resin composition by injection molding. The molding conditions of the injection molding are not particularly limited, and preferable conditions can be appropriately decided.

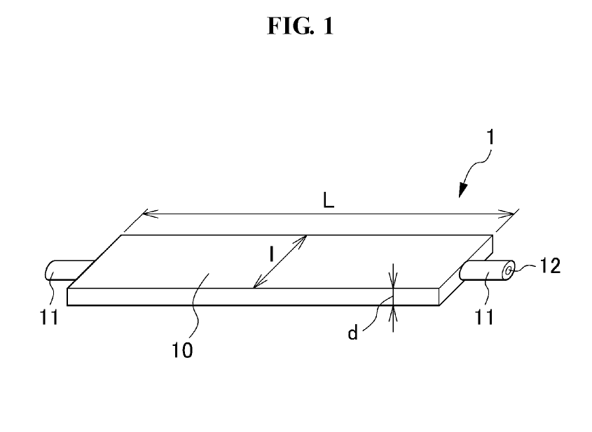

The above-described polybutylene terephthalate resin composition is suitable for producing a wind direction-controlling plate having a shape shown in FIG. 1. The wind direction-controlling plate 1 shown in FIG. 1 includes a plate-like wind direction-controlling portion 10, rotary shaft portions 11 extending from both ends of the wind direction-controlling portion in the longitudinal direction and transmitting a driving force to the wind direction-controlling plate 1, and a gate portion 12 disposed at the end of one of the rotary shaft portions 11 in the axial direction. The wind direction-controlling plate 1 will now be briefly described.

The wind direction-controlling portion 10 is in a plate shape in which the length L in the longitudinal direction is twice or more the length 1 in the short-length direction. The thickness d is 0.7 mm or more and 4 mm or less. The surface of the wind direction-controlling portion 10 is a design surface and is required to have satisfactory appearance. In order to frost the surface of the wind direction-controlling portion 10, the cavity surface may be provided with asperity.

The rotary shaft portions 11 are two shaft portions respectively extending from the ends of the wind direction-controlling portion 10 in the longitudinal direction. The angle (the angle defined by a predetermined horizontal plane and the wind direction-controlling portion) of the wind direction-controlling portion 10 is changed by rotating the rotary shaft portions 11 with a driving force from a driving device (not shown) such as a motor.

The gate portion 12 is disposed at the end of one of the rotary shaft portions 11 in the axial direction. As described above, if the gate portion 12 is disposed on the design surface, the appearance is impaired. Accordingly, molding is preferably performed such that the gate portion is disposed at one end of the wind direction-controlling portion 10 or near the end (unremarkable position). As shown in FIG. 1, the gate portion 12 disposed at the end of one of the rotary shaft portions 11 in the axial direction is unremarkable and is therefore preferred. The gate portion 12 may be also disposed at the end of the other rotary shaft portion 11 in the axial direction.

As described above, the wind direction-controlling plate 1 can be produced by an ordinary injection molding method, and the wind direction-controlling plate 1 can have further satisfactory appearance by being molded under the following conditions.

The molding conditions are preferably controlled such that the polybutylene terephthalate resin composition in a molten state, passing through a portion forming the rotary shaft portions 11 having the gate portion 12, in a cavity has a shear rate of 1×10³/sec or more and 1×10⁶/sec or less. A shear rate higher than the lower limit mentioned above allows sufficient transfer of the mold surface and thereby gives a smooth surface to the molded article to inhibit the glass fiber from floating to the surface of the wind direction-controlling plate. Thus, such a shear rate is preferred. A shear rate lower than the upper limit prevents appearance deterioration owing to spurt of the resin, called jetting, and is therefore preferred. The shear rate can be increased by elevating the injection speed, increasing the screw diameter of the molding machine, and/or reducing the diameter of the rotary shaft portion.

The holding pressure is preferably set to 30 MPa or more and 100 MPa or less and more preferably 60 MPa or more and 80 MPa or less. A holding pressure of 30 MPa or more provides satisfactory surface appearance, and a holding pressure of 100 MPa or less has an effect of maintaining the release characteristics.

The mold temperature is preferably set to 100° C. or less and more preferably 40° C. or more and 80° C. or less. A mold temperature within the above-mentioned range can be adjusted with a water-cooled mold temperature-adjusting system without using a special high-temperature adjusting system such as an oil temperature controller, can shorten the molding cycle, and also has an effect of providing satisfactory surface appearance.

### Wind Direction-Controlling Plate

The use of the polybutylene terephthalate resin composition can impart excellent physical properties to the resin molded article as described above and also can impart excellent appearance to the molded article. In addition, as described above, the polybutylene terephthalate resin composition has high fluidity when melted and has excellent moldability. Accordingly, even if the wind direction-controlling plate is in a plate shape in which the length in the longitudinal direction is twice or more that in the short-length direction, has a thickness of 0.7 mm or more and 4 mm or less, and has a gate portion at an end in the longitudinal direction of the plate or near the end, since the resin composition has high fluidity when melted, such a plate can be easily molded even at a low mold temperature without increasing the injection speed and pressure. The resulting wind direction-controlling plate has excellent appearance and excellent physical properties.

More specifically, even if the wind direction-controlling plate is in a plate shape in which the length in the short-length direction is 5 mm or more and 100 mm or less and the length in the longitudinal direction is twice or more the length in the short-length direction, has a thickness of 0.7 mm or more and 4 mm or less, and has a gate portion at an end in the longitudinal direction of the plate or near the end, the wind direction-controlling plate can have excellent appearance and excellent physical properties. The range of the moldable thickness is also affected by, for example, the lengths in the longitudinal and short-length directions of the molded article.

### EXAMPLES

The present invention will now be specifically described by, but is not limited to, the following examples and comparative examples.

### Material

Polybutylene terephthalate resin (manufactured by WinTech Polymer Ltd., intrinsic viscosity: 0.69 dL/g)

Polyethylene terephthalate resin (manufactured by Teijin Chemicals Ltd., intrinsic viscosity: 0.70 dL/g)

Glass fiber (manufactured by Nitto Boseki Co., Ltd., “CSF3PE-941”)

Inorganic filler other than the glass fiber: talc 1 (manufactured by Nippon Talc Co., Ltd., “Talc 3A”, average particle diameter: 13.8 μm)

Inorganic filler other than the glass fiber: talc 2 (manufactured by Hayashi-Kasei Co., Ltd., “Micron White #5000A”, average particle diameter: 7.6 μm)

Inorganic filler other than the glass fiber: mica (manufactured by Kuraray Trading Co., Ltd., “Suzorite mica 150-S”)

Fluidity improving agent: glycerol fatty acid partial ester (manufactured by Riken Vitamin Co., Ltd., “Rikemal HC-100”, hydroxyl value: 420)

Other glycerol compound: glycerol fatty acid ester (manufactured by Riken Vitamin Co., Ltd., “Poem S-95”, hydroxyl value: 87)

Antioxidant: hindered phenol-based antioxidant (manufactured by BASF SE, “Irganox 1010”)

Stabilizer: phosphorus-based stabilizer (manufactured by Clariant (Japan) K.K., “Hostanox P-EPQ”)

Pigment: carbon black (manufactured by Mitsubishi Chemical Corporation, “MA600B”)

Lubricant: Polyhydric alcohol fatty acid ester (manufactured by NOF Corporation, “Unistar H476”)

The above-mentioned inorganic fillers other than the glass fiber were subjected to measurement in accordance with JIS Z8825-1 with an apparatus employing laser diffraction, and the arithmetic mean of the frequency distribution was used as the average particle diameter.

### Preparation of Polybutylene Terephthalate Resin Composition

The above-mentioned materials were dry-blended at the proportions (unit: parts by mass) shown in Table 1 and were fed to a twin-screw extruder having a screw diameter of 30 mm (manufactured by The Japan Steel Works, Ltd.) from the hopper, followed by melt kneading at 260° C. to obtain each polybutylene terephthalate resin composition in a pellet form.

### [Tensile Properties]

Each of the resulting resin compositions in a pellet form was molded into test pieces by injection molding at a molding temperature of 260° C. and a mold temperature of 80° C. The tensile strengths and tensile elongations of the test pieces were measured in accordance with ISO 527-1, 2. The measurement results are shown in Table 1.

### [Flexural Properties]

Each of the resulting resin compositions in a pellet form was molded into test pieces by injection molding at a molding temperature of 260° C. and a mold temperature of 80° C. The flexural strengths and the flexural modulus of the test pieces were measured in accordance with ISO 178. The measurement results are shown in Table 1.

### [Impact Resistance]

Each of the resulting resin compositions in a pellet form were molded into Charpy impact test pieces by injection molding at a molding temperature of 260° C. and a mold temperature of 80° C. The test pieces were evaluated at 23° C. in accordance with evaluation criteria defined in ISO 179/1 eA. The measurement results are shown in Table 1.

### [Fluidity]

The melt viscosity of each resin composition in a pellet form was measured with Capillograph 1B manufactured by Toyo Seiki Seisaku-Sho, Ltd. in accordance with ISO 11443 at a furnace temperature of 260° C., a capillary diameter of 1 mm and a length of 20 mm, and a shear rate of 1000 sec⁻¹. The measurement results are shown in Table 1.

TABLE 1

| | Example 1 | Example 2 | Example 3 | Example 4 |
|---|---|---|---|---|
| PBT | 59.5 | 59.5 | 61.8 | 61.8 |
| PET | 40.5 | 40.5 | 38.2 | 38.2 |
| Glass fiber | 125.9 | 103.0 | 103.0 | 114.4 |
| Talc 1 | | 22.9 | | |
| Talc 2 | | | 22.9 | |
| Mica | | | | 11.4 |
| Fluidity-improving | 0.9 | 0.9 | 0.9 | 0.9 |
| agent | | | | |
| Antioxidant | 0.2 | 0.2 | 0.2 | 0.2 |
| Stabilizer | | | | |
| Pigment | 1.1 | 1.1 | 1.1 | 1.1 |
| Lubricant | 0.7 | 0.7 | 0.7 | 0.7 |
| Tensile strength | 159 | 124 | 125 | 163 |
| (MPa) | | | | |
| Tensile elongation | 1.1 | 0.9 | 0.9 | 1.2 |
| (%) | | | | |
| Flexural strength | 246 | 191 | 193 | 241 |
| (MPa) | | | | |
| Flexural modulus | 19,600 | 18,200 | 18,300 | 19,700 |
| (MPa) | | | | |
| Charpy (kJ/m2) | 10.3 | 8.0 | 8.2 | 9.4 |
| Melt viscosity | 0.26 | 0.27 | 0.26 | 0.29 |
| (kPa · s) | | | | |

| | Comparative | Comparative | Comparative | Comparative | Comparative | Comparative |
|---|---|---|---|---|---|---|
| | Example 1 | Example 2 | Example 3 | Example 4 | Example 5 | Example 6 |
| PBT | 71.5 | 62.0 | 52.5 | 64.3 | 59.5 | 59.5 |
| PET | 28.5 | 38.0 | 47.5 | 35.7 | 40.5 | 40.5 |
| Glass fiber | 125.9 | 125.9 | 125.9 | 125.9 | 125.9 | 125.9 |
| Fluidity-improving | | | | | | 0.9 |
| agent | | | | | | |
| Other glycerol | | | | | 0.9 | |
| compound | | | | | | |
| Antioxidant | 0.2 | 0.2 | 0.2 | 0.2 | 0.2 | 0.2 |
| Stabilizer | 0.2 | 0.2 | 0.2 | 0.2 | | 0.2 |
| Pigment | 1.1 | 1.1 | 1.1 | 1.1 | 1.1 | 1.1 |
| Lubricant | 0.7 | 0.7 | 0.7 | 0.7 | 0.7 | 0.7 |
| Tensile strength | 171 | 171 | 175 | 171 | 160 | 158 |
| (MPa) | | | | | | |
| Tensile elongation | 1.4 | 1.4 | 1.5 | 1.4 | 1.1 | 1.1 |
| (%) | | | | | | |
| Flexural strength | 260 | 265 | 261 | 266 | 243 | 246 |
| (MPa) | | | | | | |
| Flexural modulus | 19,300 | 19,300 | 19,200 | 19,300 | 19,500 | 19,600 |
| (MPa) | | | | | | |
| Charpy (kJ/m2) | 9.9 | 9.7 | 9.3 | 9.6 | 9.9 | 10 |
| Melt viscosity | 0.33 | 0.34 | 0.37 | 0.34 | 0.33 | 0.31 |
| (kPa · s) | | | | | | |

### Production of Wind Direction-Controlling Plate

A wind direction-controlling plate having a shape shown FIG. 1 was produced by injection molding each of the polybutylene terephthalate resin compositions in a pellet form prepared above. The length L is 130 mm; the length l is 13 mm; and the thickness d is 3.2 mm. The rotary shaft portion is in a columnar shape having a radius of 1 mm.

The plates were produced at two different holding pressure of 60 MPa and 80 MPa and at three different injection speeds of 10 mm/s, 50 mm/s, and 100 mm/s. Accordingly, the polybutylene terephthalate resin compositions were each molded into wind direction-controlling plates under six different molding conditions. The mold temperature was set to 80° C.

The flow rate per unit time was calculated from the injection speed and screw diameter. The calculation results are shown in Table 2. The shear rate was calculated from the flow rate and the shape of the rotary shaft portion (the radius of the column). The calculation results are shown in Table 2.

TABLE 2

| Injection speed | Screw diameter | Flow rate | Shear rate |
|---|---|---|---|
| (mm/s) | (mm) | (mm³/s) | (sec⁻¹) |
| 10 | 28 | 6158 | 7.8 × 10³ |
| 50 | 28 | 30788 | 3.9 × 10⁴ |
| 100 | 28 | 61575 | 7.8 × 10⁴ |

### [Appearance]

Wind direction-controlling plates were produced using the polybutylene terephthalate resin compositions of Examples and Comparative Examples as raw materials, and the appearance of the plates were visually evaluated. The evaluation criteria are the following three grades. The results are shown in Table 3.

“⊙”: no jetting, floating of glass, and cloudiness of the surface are visually observed;

“◯”: no significant jetting and floating of glass are visually observed, but slight jetting and/or cloudiness of the surface is visually observed; and

“X”: significant jetting and/or floating of glass is visually observed.

TABLE 3

| | | | Example 1 | Example 2 | Example 3 | Example 4 |
|---|---|---|---|---|---|---|
| PBT | | | 59.5 | 59.5 | 61.8 | 61.8 |
| PET | | | 40.5 | 40.5 | 38.2 | 38.2 |
| Glass fiber | | | 125.9 | 103.0 | 103.0 | 114.4 |
| Talc 1 | | | | 22.9 | | |
| Talc 2 | | | | | 22.9 | |
| Mica | | | | | | 11.4 |
| Fluidity-improving agent | | | 0.9 | 0.9 | 0.9 | 0.9 |
| Antioxidant | | | 0.2 | 0.2 | 0.2 | 0.2 |
| Stabilizer | | | | | | |
| Pigment | | | 1.1 | 1.1 | 1.1 | 1.1 |
| Lubricant | | | 0.7 | 0.7 | 0.7 | 0.7 |
| Molding | 60 | 10 mm/s | ⊚ | ⊚ | ◯ | ◯ |
| condition | (MPa) | 50 mm/s | — | — | — | — |
| | | 100 mm/s | — | — | — | — |
| | 80 | 10 mm/s | — | — | — | — |
| | (MPa) | 50 mm/s | — | — | — | — |
| | | 100 mm/s | — | — | — | — |
| | | | Comparative | Comparative | Comparative | Comparative |
| | | | Example 1 | Example 2 | Example 3 | Example 4 |
| PBT | | | 71.5 | 62.0 | 52.5 | 64.3 |
| PET | | | 28.5 | 38.0 | 47.5 | 35.7 |
| Glass fiber | | | 125.9 | 125.9 | 125.9 | 125.9 |
| Fluidity-improving agent | | | | | | |
| Antioxidant | | | 0.2 | 0.2 | 0.2 | 0.2 |
| Stabilizer | | | 0.2 | 0.2 | 0.2 | 0.2 |
| Pigment | | | 1.1 | 1.1 | 1.1 | 1.1 |
| Lubricant | | | 0.7 | 0.7 | 0.7 | 0.7 |
| Molding | 60 | 10 mm/s | X | ◯ | ⊚ | X |
| condition | (MPa) | 50 mm/s | — | — | — | X |
| | | 100 mm/s | — | — | — | ◯ |
| | 80 | 10 mm/s | — | — | — | X |
| | (MPa) | 50 mm/s | — | — | — | ◯ |
| | | 100 mm/s | — | — | — | ◯ |

It can be confirmed from the physical properties of the polybutylene terephthalate resin compositions shown in Table 1 and the appearance evaluation results of the wind direction-controlling plates shown in Table 3 that though the wind direction-controlling plates are molded from polybutylene terephthalate resin compositions having high fluidity when melted, the plates have excellent appearance and excellent mechanical properties.

1. A wind direction-controlling plate being in a plate shape in which the length in the longitudinal direction is twice or more that in the short-length direction, and
having a thickness of 0.7 mm or more and 4 mm or less, wherein
the wind direction-controlling plate is formed by injection molding of a polybutylene terephthalate resin composition containing a polybutylene terephthalate resin, a polyethylene terephthalate resin, and glass fiber and having a melt viscosity of 0.10 kPa·s or more and 0.30 kPa·s or less at a temperature of 260° C. and a shear rate of 1000 sec⁻¹ from a gate at an end in the longitudinal direction of the plate or near the end.

2. The wind direction-controlling plate according to claim 1, wherein
the polybutylene terephthalate resin composition has:
a flexural modulus of 15000 MPa or more and a flexural strength of 170 MPa or more measured in accordance with ISO 178; and
a Charpy impact value of 7 kJ/m² or more measured in accordance with ISO 179/1 eA.

3. The wind direction-controlling plate according to claim 1, wherein
the polybutylene terephthalate resin composition:
has a mass ratio of the polybutylene terephthalate resin to the polyethylene terephthalate resin (content of polybutylene terephthalate resin/content of polyethylene terephthalate resin) of 4/6 or more and 7/3 or less;
contains the glass fiber in a content of 80 parts by mass or more and 140 parts by mass or less based on 100 parts by mass of the sum of the content of the polybutylene terephthalate resin and the content of the polyethylene terephthalate resin;
further contains an inorganic filler other than the glass fiber in a content of 40 parts by mass or less; and
further contains a polyhydric alcohol fatty acid partial ester in a content of 3 parts by mass or less.

4. The wind direction-controlling plate according to claim 3, wherein the inorganic filler is talc having a particle diameter of 10 μm or more and 30 μm or less.

5. The wind direction-controlling plate according to claim 1, wherein
the wind direction-controlling plate includes rotary shaft portions extending from both ends of the wind direction-controlling plate in the longitudinal direction and transmitting a driving force to the plate; and
the gate is disposed on one of the rotary shaft portions or at the end of one of the rotary shaft portions in the axial direction.

6. A method of producing the wind direction-controlling plate according to claim 5 by injection molding, wherein
the injection molding is performed controlling the polybutylene terephthalate resin composition in a molten state, passing through the rotary shaft portions, in a cavity so as to have a shear rate of 1×10³/sec or more and 1×10⁶/sec or less,
at a holding pressure of 30 MPa or more and 100 MPa or less and
a mold temperature of 100° C. or less.
